(19) United States
(12) Patent Application Publication
(10) Pub. No.: US 2021/0187739 A1
(43) Pub. Date: Jun. 24, 2021

(54) ROBOT AND ROBOT SYSTEM

(71) Applicant: LG ELECTRONICS INC., Seoul (KR)

(72) Inventor: Kilsu JUNG, Seoul (KR)

(21) Appl. No.: 17/096,735

(22) Filed: Nov. 12, 2020

(30) Foreign Application Priority Data
Dec. 18, 2019 (KR) 10-2019-0170030

(51) Int. Cl. B25J 9/16; H04W 4/029

(52) U.S. Cl. CPC B25J 9/1664; G06K 9/00664; B25J 9/1697; H04W 4/029

(57) ABSTRACT

Disclosed are a method for tracking an object by a plurality of robots associated with each other, and a robot and a robot system which provide seamless interaction using the method. The robot may communicate with other electronic equipment and servers in a 5G communication environment.

### CROSS-REFERENCE TO RELATED APPLICATION

This application claims priority under 35 U.S.C. § 119 to Korean Application No. 10-2019-0170030 filed on Dec. 18, 2019, whose entire disclosure is hereby incorporated by reference.

### BACKGROUND

### 1. Field

The present disclosure relates to a robot and a robot system configured to track an object based on landmark information.

### 2. Background

Recently, robots which can be conveniently used in daily life have been actively developed. Such robots interact with people to provide assistance in their daily lives, at homes, schools, and public places. Speech recognition technology is being widely utilized as an interface method for interaction between robots and humans.

In cases of a fixed robot, such as a home robot, which does not move, or a robot with a small moving radius, it is difficult for interaction to take place between an object and the robot when outside the operation radius of the robot. Thus, technology that provides seamless interaction for a moving object is required.

### BRIEF DESCRIPTION OF THE DRAWINGS

The embodiments will be described in detail with reference to the following drawings in which like reference numerals refer to like elements wherein:

FIG. 1 is an exemplary diagram illustrating an operation environment of a robot according to an embodiment of the present disclosure;

FIG. 2 is a block diagram illustrating a robot according to an embodiment of the present disclosure;

FIG. 3 is a flow diagram illustrating a method for tracking an object according to an embodiment of the present disclosure;

FIG. 4 is a diagram illustrating the method for tracking an object according to an embodiment of the present disclosure;

FIG. 5 is a flow diagram illustrating a process of tracking an object according to an embodiment of the present disclosure;

FIG. 6 is a diagram illustrating a state transition of the robot according to an embodiment of the present disclosure;

FIG. 7 is a signal flow diagram illustrating the process of tracking an object in a robot system according to an embodiment of the present disclosure;

FIG. 8 is a table illustrating a visual map according to an embodiment of the present disclosure; and

FIG. 9 is a block diagram illustrating a server according to an embodiment of the present disclosure.

### DETAILED DESCRIPTION

Advantages and features of the present disclosure and methods for achieving them will become apparent from the descriptions of aspects herein below with reference to the accompanying drawings. However, the present disclosure is not limited to the aspects disclosed herein but may be implemented in various different forms. The aspects are provided to make the description of the present disclosure thorough and to fully convey the scope of the present disclosure to those skilled in the art. It is to be noted that the scope of the present disclosure is defined only by the claims.

Hereinafter, embodiments disclosed herein will be described in detail with reference to the accompanying drawings, and the same reference numerals are given to the same or similar components and duplicate descriptions thereof will be omitted. In addition, in describing an embodiment disclosed in the present document, if it is determined that a detailed description of a related art incorporated herein unnecessarily obscure the gist of the embodiment, the detailed description thereof will be omitted.

The terminology used herein is used for the purpose of describing particular exemplary embodiments only and is not intended to be limiting. As used herein, the articles “a,” “an,” and “the,” include plural referents unless the context clearly dictates otherwise. The terms “comprise,” “comprising,” “includes,” “including,” “containing,” “has,” “having” or other variations thereof are inclusive and therefore specify the presence of stated features, integers, steps, operations, elements, and/or components, but do not preclude the presence or addition of one or more other features, integers, steps, operations, elements, components, and/or a combination thereof. Furthermore, these terms such as “first,” “second,” and other numerical terms, are used only to distinguish one element from another element. These terms are generally only used to distinguish one element from another.

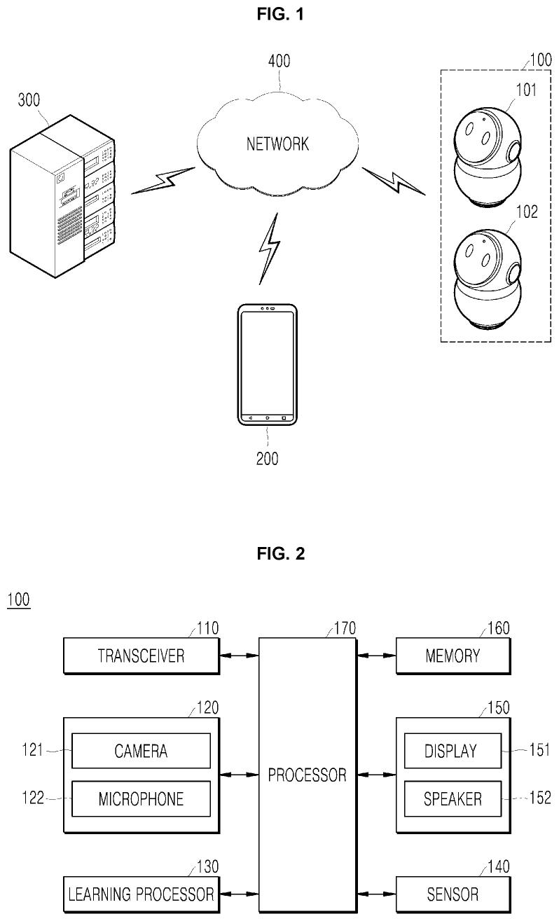

FIG. 1 is an exemplary diagram illustrating an operation environment of a robot according to an embodiment of the present disclosure. A robot operation environment may include a robot 100, a terminal 200, a server 300, and a network 400 configured to connect the above components. Various electronic devices other than the devices shown in FIG. 1 may be interconnected through the network 400 and operated.

According to an embodiment of the present disclosure, the robot 100 may be composed of a robot system that includes a first robot 101 and a second robot 102. The first robot 101 and the second robot 102 are exemplary, and the robot system may include one or more robots 100.

Hereinafter, the at least one robot 100 includes the first robot 101 and the second robot 102. Each of the first robot 101 and the second robot 102 may include the same configuration as that of the robot 100 and perform the same function as that of the robot 100. The first robot 101 and the second robot 102 may constitute the robot system to work in collaboration with each other.

The robot 100 may perform an interaction with an object. The object in an example includes a user. The object in another example includes the other robot 100. For example, the interaction includes recognizing an object based on sound and/or vision, providing information by visual and/or auditory transmission means, and providing a service for the object. For example, the interaction includes a conversation with the object, a news briefing for the object and a response to a request of the object.

The object may move while the interaction with the robot 100 is being performed. For example, the object may move within a space where the robot 100 is disposed, or outside the space, or from a first space to a second space.

The robot 100 may track the object for effective interaction. According to an embodiment of the present disclosure, the object is tracked based on a landmark present in a space where the robot 100 stays. A landmark refers to an object or a place which marks a space. According to an embodiment of the present disclosure, the robot 100 may specify a location of the object by using a landmark.

The robot system may track a moving object to provide a seamless interaction for the object. For example, the robot system, which includes the first robot 101 disposed in a first space and the second robot 102 disposed in a second space, may provide a seamless interaction for the object that moves from the first space to the second space. For example, the first robot 101 may provide interaction while the object stays in the first space, and the second robot 102 may seamlessly continue providing the interaction while the object leaves the first space and enters the second space to stay in the second space.

The robot 100 may refer to a machine which automatically handles a given task by its own ability, or which operates autonomously. In particular, a robot having a function of recognizing an environment and performing an operation according to its own judgment may be referred to as an intelligent robot. The robot 100 may be classified into industrial, medical, household, and military robots, according to the purpose or field of use.

The robot 100 may include an actuator or a driver including a motor in order to perform various physical operations, such as moving joints of the robot. Moreover, a movable robot may include, for example, a wheel, a brake, and a propeller in the driving unit thereof, and through the driving unit may thus be capable of traveling on the ground or flying in the air. By employing AI technology, the robot 100 may be implemented as a guide robot, a transport robot, a cleaning robot, a wearable robot, an entertainment robot, a pet robot, an unmanned flying robot, or a home robot.

The robot 100 may include a robot control module for controlling its motion. The robot control module may correspond to a software module or a chip that implements the software module in the form of a hardware device. Using sensor information obtained from various types of sensors, the robot 100 may obtain status information of the robot 100, detect (recognize) the surrounding environment and objects, generate map data, determine a movement route and drive plan, determine a response to a user interaction, or determine an operation. Here, in order to determine the movement route and drive plan, the robot 100 may use sensor information obtained from at least one sensor among lidar, radar, and a camera.

The robot 100 may perform the operations above by using a learning model configured by at least one artificial neural network. For example, the robot 100 may recognize the surrounding environment and objects by using the learning model and determine its operation by using the recognized surrounding environment information or object information. Here, the learning model may be trained by the robot 100 itself or trained by an external device such as the server 300. At this time, the robot 100 may perform the operation by generating a result by employing the learning model directly, but may also perform the operation by transmitting sensor information to an external device such as the server 300 and receiving a result generated accordingly.

The robot 100 may determine the movement route and drive plan by using at least one of object information detected from the map data and sensor information or object information obtained from an external device, and drive according to the determined movement route and drive plan by controlling its locomotion platform. The map data may include object identification information about various objects disposed in the space in which the robot 100 drives. For example, the map data may include object identification information about static objects such as wall and doors and movable objects such as a flowerpot and a desk. In addition, the object identification information may include the name, type, distance, location, and so on.

Also, the robot 100 may perform the operation or drive by controlling its locomotion platform based on the control and interaction of the user. At this time, the robot 100 may obtain intention information of the interaction according to motion or spoken utterance of the user, and perform an operation by determining a response based on the obtained intention information.

Artificial intelligence refers to a field of studying artificial intelligence or a methodology for creating the same. Moreover, machine learning refers to a field of defining various problems dealing in an artificial intelligence field and studying methodologies for solving the same. In addition, machine learning may be defined as an algorithm for improving performance with respect to a task through repeated experience with respect to the task.

An artificial neural network (ANN) is a model used in machine learning, and may refer in general to a model with problem-solving abilities, composed of artificial neurons (nodes) forming a network by a connection of synapses. The ANN may be defined by a connection pattern between neurons on different layers, a learning process for updating model parameters, and an activation function for generating an output value.

The artificial neural network may include an input layer, an output layer, and optionally one or more hidden layers. Each layer includes one or more neurons, and the artificial neural network may include synapses that connect the neurons to one another. In an ANN, each neuron may output a function value of an activation function with respect to the input signals inputted through a synapse, weight, and bias.

A model parameter refers to a parameter determined through learning, and may include weight of synapse connection, bias of a neuron, and the like. Moreover, hyperparameters refer to parameters which are set before learning in a machine learning algorithm, and include a learning rate, a number of iterations, a mini-batch size, an initialization function, and the like.

The objective of training an artificial neural network is to determine a model parameter for significantly reducing a loss function. The loss function may be used as an indicator for determining an optimal model parameter in a learning process of an artificial neural network.

The machine learning may be classified into supervised learning, unsupervised learning, and reinforcement learning depending on the learning method. Supervised learning may refer to a method for training the artificial neural network with training data that has been given a label. In addition, the label may refer to a target answer (or a result value) to be inferred by the artificial neural network when the training data is inputted to the artificial neural network. Unsupervised learning may refer to a method for training an artificial neural network using training data that has not been given a label. Reinforcement learning may refer to a learning method for training an agent defined within an environment to select an action or an action order for maximizing cumulative rewards in each state.

Machine learning of an artificial neural network implemented as a deep neural network (DNN) including a plurality of hidden layers may be referred to as deep learning, and the deep learning is one machine learning technique. Hereinafter, the meaning of machine learning includes deep learning.

The terminal 200 is an electronic device controlled by a user or an operator, and the user may drive an application for controlling the robot 100, or may access an application installed in an external device, including the server 300, using the terminal 200. The terminal 200 may receive state information of the robot 100 from the robot 100 and/or the server 300 through the network 400. The terminal 200 may provide a function for monitoring the robot 100 through an application equipped therein for a user.

The terminal 200 may include a communication terminal capable of performing a function of a computing device (not shown). Here, the terminal 200 may be, but is not limited to, a desktop computer, a smartphone, a laptop computer, a tablet PC, a smart TV, a cellular phone, a personal digital assistant (PDA), a media player, a micro-server, a global positioning system (GPS) device, an electronic book terminal, a digital broadcasting terminal, a navigation device, a kiosk, an MP3 player, a digital camera, an electric home appliance, or any of other mobile or immobile computing devices configured to be manipulated by a user. In addition, the terminal 200 may be a wearable device having a communication function and a data processing function, such as a watch, glasses, a hair band, or a ring. The terminal 200 is not limited to the above, and any terminal capable of performing web browsing may be used without limitation.

The server 300 may include a database server configured to store and provide landmark information. The server 300 may include an application server configured to receive information on a last detected position of an object from the robot 100, determine a potential position of the object based on the landmark information stored in the server 300 and provide the determined potential position to the robot 100.

The server 300 may include an application server or a web server configured to monitor the robot 100 by using a web browser or application installed in the terminal 200. The server 300 may be a database server that provides big data necessary for applying various artificial intelligence algorithms and data relating to a robot control.

The network 400 may serve to connect the robot 100, the terminal 200, and the server 300 to each other. The network 400 may include a wired network such as a local area network (LAN), a wide area network (WAN), a metropolitan area network (MAN), or an integrated service digital network (ISDN), and a wireless network such as a wireless LAN, a CDMA, Bluetooth®, or satellite communication, but the present disclosure is not limited to these examples. Furthermore, the network 400 may transmit/receive information using short-range communications and/or long-distance communications. Short-range communication may include Bluetooth®, radio frequency identification (RFID), infrared data association (IrDA), ultra-wideband (UWB), ZigBee, and Wi-Fi (wireless fidelity) technologies, and the long distance communication may include code division multiple access (CDMA), frequency division multiple access (FDMA), time division multiple access (TDMA), orthogonal frequency division multiple access (OFDMA), and single carrier frequency division multiple access (SC-FDMA).

The network 400 may include connection of network elements such as hubs, bridges, routers, switches, and gateways. The network 400 may include one or more connected networks, including a public network such as Internet and a private network such as a secure corporate private network, for example, a multiple network environment. Access to the network 400 can be provided via one or more wired or wireless access networks. Furthermore, the network 400 may support the Internet of things (loT) for 5G communication or exchanging and processing information between distributed elements such as objects.

FIG. 2 is a block diagram illustrating a robot according to an embodiment of the present disclosure. The robot 100 may include a transceiver 110, an input interface 120, a learning processor 130, a sensor 140, an output interface 150, a memory 160, a processor 170, and the like. The robot 100 may include more components or fewer components than those listed in the above.

The transceiver 110 may transmit/receive data with external devices such as other AI devices or the server 300 by using wired or wireless communication technology. For example, the communicator 110 may transmit or receive sensor data, user input, a learning model, a control signal, and the like with the external devices. The Al device may also, for example, be realized by a stationary or a mobile device, such as a TV, a projector, a mobile phone, a smartphone, a laptop computer, a digital broadcasting terminal, a personal digital assistant (PDA), a portable multimedia player (PMP), a navigation device, a tablet PC, a wearable device, a set top box (STB), a DMB receiver, a radio, a washer, a refrigerator, digital signage, a robot, or a vehicle.

The communication technology used by the transceiver 110 may be technology such as global system for mobile communication (GSM), code division multi access (CDMA), long term evolution (LTE), 5G, wireless LAN (WLAN), Wireless-Fidelity (Wi-Fi), Bluetooth™, radio frequency identification (RFID), infrared data association (IrDA), ZigBee, and near field communication (NFC). The transceiver may include, for example, a transmitter, a receiver, a transceiver, a modem, a port, a controller, and an antenna so as to perform a function of transmitting and receiving data for various types of communications.

The robot 100 may communicate with at least one other robot 100 through the transceiver 110. The transceiver 110 may transmit information on the set of landmarks stored in the memory 160 to at least one other robot 100 under the control of the processor 170. The transceiver 110 may receive information on the other set of landmarks from at least one other robot 100 under the control of the processor 170.

The transceiver 110 may communicate with the server 300 under the control of the processor 170. For example, the robot 100 may receive an object recognition model from the server 300 through the transceiver 110.

The transceiver 110 may communicate with the terminal 200 under the control of the processor 170. For example, the robot 100 may receive a control signal from the terminal 200 through the transceiver 110.

The input interface 120 may operate with sensor 140 or may include other sensors to obtain various types of data. The input interface 120 may include, for example, a camera configured to receive an image signal, a microphone 122 configured to receive an audio signal, and a keyboard/keypad (not shown) configured to receive information from a user. Here, the camera 121 or the microphone 122 may be regarded as a sensor, and therefore a signal acquired from the camera 121 or the microphone 122 may be sensing data or sensor information.

The robot 100 may sense a sound generated from the surroundings by the microphone 122. The robot 100 may detect an input sound by the microphone 122. For example, the robot 100 may preprocess the surrounding sound sensed by the microphone 122 through a noise removal filter under the control of the processor 170 to acquire an input sound.

The robot 100 may obtain a surrounding image through the camera 121 under the control of the processor 170. The robot 100 may generate landmark information based on an image photographed by the camera 121 under the control of the processor 170. The processor 170 may extract an input feature from the image acquired through the camera 121.

The robot 100 may track a user based on the image photographed by the camera 121 under the control of the processor 170. For this tracking, the robot 100 may use the landmark information stored in the memory 160.

The robot 100 may acquire an image of a specific region in a space through the camera 121 under the control of the processor 170. For example, the robot 100 may acquire an image of a potential position of an object through the camera 121 under the control of the processor 170. Moreover, the robot 100 may scan a space through the camera 121 under the control of the processor 170 to generate a scan image. Additionally, the robot 100 may acquire an image of a landmark corresponding to the position of the object through the camera 121 under the control of the processor 170.

The input interface 120 may obtain, for example, learning data for model learning and input data used when output is obtained using a learning model. The input interface 120 may obtain raw input data. In this case, the processor 170 or the learning processor 130 may extract an input feature by preprocessing the input data.

The learning processor 130 may allow a model, composed of an artificial neural network to be trained using learning data. Here, the trained artificial neural network may be referred to as a learning model. The trained model may be used to infer a result value with respect to new input data rather than learning data, and the inferred value may be used as a basis for a determination to perform an operation of classifying the detected hand motion. For example, the learning model equipped in the server 200 or the robot 100 may be used to recognize an object. The learning model may include an object recognition model configured to recognize an object from an input image. The processor 170 may generate landmark information based on information on the object recognized by using the object recognition model. At this time, the learning processor 130 may perform AI processing together with a learning processor 320 of the server 300.

The learning processor 130 may include a memory integrated or implemented in the robot 100. Alternatively, the learning processor 130 may also be implemented by using a memory 160, an external memory directly coupled to the robot 100, or a memory held in an external device. The learning processor 130 may correspond to the processor 170.

The sensor 140 may acquire at least one of internal information of the robot 100, surrounding environment information of the robot 100, or user information by using various sensors. The sensor 140 may include at least one sensor.

The sensor 140 may include an image sensor, a proximity sensor, an illumination sensor, an acceleration sensor, a magnetic sensor, a gyroscope sensor, an inertial sensor, an RGB sensor, an infrared (IR) sensor, a finger scan sensor, an ultrasonic sensor, an optical sensor, a microphone, a light detection and ranging (lidar) sensor, radar, or a combination thereof.

The sensor 140 may acquire various kinds of data, such as learning data for model learning and input data used when an output is acquired using a learning model. The sensor 140 may obtain raw input data. In this case, the processor 170 or the learning processor 130 may extract an input feature by preprocessing the input data.

The output interface 150 may generate a visual, auditory, or tactile related output. Here, the output interface 150 may include, for example, a display 151 configured to output visual information, a speaker 152 configured to output auditory information, and a haptic module (not shown) configured to output haptic information. The display 151 may output a message under the control of the processor 170. The speaker 152 may output a voice message or an alarm sound under the control of the processor 170.

The memory 160 may store data supporting various functions of the robot 100. For example, the memory 160 may store input data obtained by the input interface 120, sensor information obtained by the sensor 140, learning data, a learning model, a learning history, and the like.

The memory 160 may store information on a set of landmarks present in a space where the robot 100 is disposed. The information on a set of landmarks may be used to track the location of the object. The information on a set of landmarks stored in the memory 160 may be generated and updated under the control of the processor 170. Further, the memory 160 may store a visual map generated based on the information on a set of landmarks.

The memory 160 may store an object recognition model. The object recognition model stored in the memory 160 may be used to recognize the landmark from the image under the control of the processor 170. The processor 170 may receive the object recognition model from the server 300 through the transceiver 110 and store the object recognition model in the memory 160. The processor 170 may receive update information on the object recognition model from the server 300 through the transceiver 110 to reflect the received update information on the object recognition model stored in the memory 160. In addition, the memory 160 may store map data of the space where the robot 100 is disposed.

The memory 160 may include, but is not limited to, magnetic storage media or flash storage media. This memory 160 may include an internal memory and/or an external memory and may include a volatile memory such as a DRAM, a SRAM or a SDRAM, and a non-volatile memory such as one time programmable ROM (OTPROM), a PROM, an EPROM, an EEPROM, a mask ROM, a flash ROM, a NAND flash memory or a NOR flash memory, a flash drive such as an SSD, a compact flash (CF) card, an SD card, a Micro-SD card, a Mini-SD card, an XD card or memory stick, or a storage device such as a HDD.

The processor 170 is a type of a central processor unit which may drive control software provided in the memory 160 to control the operation of the robot 100. The processor 170 may include all kinds of devices capable of processing data. Here, the processor 170 may, for example, refer to a data processing device embedded in hardware, which has a physically structured circuitry to perform a function represented by codes or instructions contained in a program. As examples of the data processing device embedded in hardware, a microprocessor, a central processor (CPU), a processor core, a multiprocessor, an application-specific integrated circuit (ASIC), a field programmable gate array (FPGA), and the like may be included, but the scope of the present disclosure is not limited thereto. The processor 170 may include one or more processors.

The processor 170 may determine at least one executable operation of the robot 100, based on information determined or generated using a data analysis algorithm or a machine learning algorithm. In addition, the processor 170 may control components of the robot 100 to perform the determined operation.

To this end, the processor 170 may request, retrieve, receive, or use data of the learning processor 130 or the memory 160, and may control components of the robot 100 to execute a predicted operation or an operation determined to be preferable of the at least one executable operation. At this time, if the connection of the external device is required to perform the determined operation, the processor 170 may generate a control signal for controlling the corresponding external device, and transmit the generated control signal to the corresponding external device.

The processor 170 may obtain intent information regarding a user input, and may determine a requirement of a user based on the obtained intent information. The processor 170 may obtain the intent information corresponding to a user input by using at least one of a speech to text (STT) engine for converting a speech input into a character string or a natural language processing (NLP) engine for obtaining intent information of natural language.

In an embodiment, the at least one of the STT engine or the NLP engine may be composed of artificial neural networks, some of which are trained according to a machine learning algorithm. In addition, the at least one of the STT engine or the NLP engine may be trained by the learning processor 130, trained by a learning processor 320 of an server 300, or trained by distributed processing thereof.

The processor 170 may collect history information including, for example, operation contents and user feedback on an operation of the robot 100, and store the history information in the memory 160 or the learning processor 130, or may transmit the history information to an external device such as a server 300. The collected history information may be used to update a learning model.

The processor 170 may control at least some of components of the robot 100 to drive an application stored in the memory 160. Furthermore, the processor 170 may operate two or more components included in the robot 100 in combination with each other to drive the application. The processor 170 is coupled to the memory 160. Here, ‘coupled’ means that physical and logical paths capable of transmitting and receiving a control signal and data are present.

The processor 170 may be configured to determine an initial position of an object based on a potential position of the object, determine a first landmark from the set of landmarks stored in the memory 160 corresponding to at least one detected position of the object from the set of landmarks stored in the memory 160 depending according to movement of the object, and transmit a second landmark corresponding to a last detected position of the object to at least one other robot. Here, the processor 170 being configured to perform a specific operation means that the processor 170 is set to perform a series of commands stored in the memory 160 so as to perform the corresponding operation.

The processor 170 may be further configured to direct a field of view of the robot towards the potential position of the object, such as to turn a body of the robot to position a sensor of the robot to detect a region associated with the potential position. For example, the potential position of the object is a third landmark corresponding to a location where the object was lost in a space where at least one other robot is disposed, and the processor 170 may be further configured to determine an initial position of the object based on the third landmark.

The processor 170 may be further configured to determine whether the third landmark corresponding to the location where the object was lost in the space where at least one other robot is disposed corresponds to one of the set of landmarks stored in the memory 160. For example, the potential position of the object is a sound source location acquired by estimating a sound source of an input sound triggered by the object, and the processor 170 may be further configured to determine an initial position of the object based on the sound source location.

The processor 170 may be further configured to update the information on the set of landmarks based on the landmark corresponding to the initial position of the object. The processor 170 may be further configured to move the field of view of the robot according to the movement of the object so as to determine the first landmark. The processor 170 may be further configured to determine a series of the first landmarks corresponding to the current position of the object that alters according to the movement of the object so as to determine the first landmark.

The processor 170 may be further configured to determine the first landmark corresponding to at least one detected position of the object right before the object was lost in the space where the robot 100 is disposed as the second landmark corresponding to the last detected position so as to transmit the second landmark to at least one other robot 100.

The processor 170 may be further configured to generate a visual map of the space that represents a spatial connection between the robot 100 and at least one other robot 100 based on the information on the set of landmarks. The processor 170 may be further configured to update the visual map in at least one of periodically or depending on a change in a location of the robot.

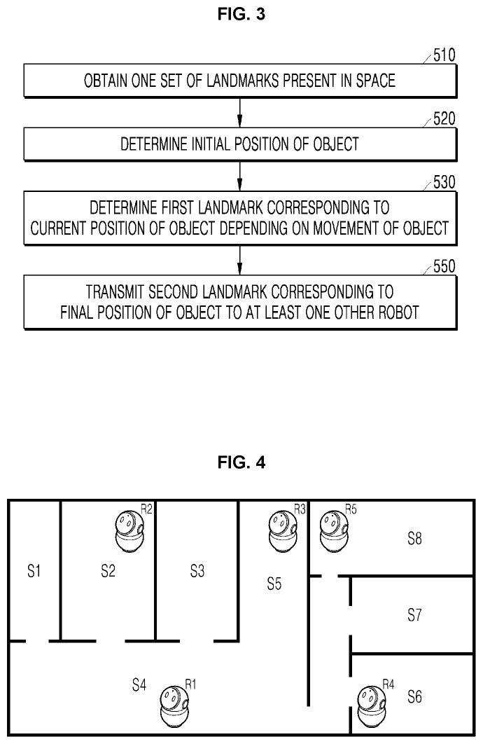

FIG. 3 is a flow diagram illustrating a method for tracking an object according to an embodiment of the present disclosure. According to an embodiment of the present disclosure, the method for tracking an object may include determining a set of landmarks present in a space (510), determining an initial position of an object (520), determining a first landmark, of the set of landmarks, corresponding to a detected position of the object during a movement of the object (530), and transmitting to another device a second landmark, of the set of landmarks, corresponding to a last detected position of the object (550).

In step 510, the processor 170 may determine a set of landmarks present in a space where the robot 100 is disposed or a space that is detected by the robot. According to an embodiment of the present disclosure, the memory 160 may store information on the set of landmarks present in the space where the robot 100 is disposed. The processor 170 may access the memory 160 coupled to the processor 170 to obtain information on the set of landmarks present in the space where the robot 100 is disposed.

According to an embodiment of the present disclosure, the server 300 may store the information on the landmark, and in response to a request of the robot 100, transmit the information on the set of landmarks present in the space where the robot 100 is disposed. The processor 170 may obtain the information on the set of landmarks present in the space where the robot 100 is disposed from the server 300 through the transceiver 110.

A landmark represents an object or a place which marks a space. For example, a landmark includes objects located in a space (for example, furniture, home appliances, picture frames, carpets, lights, and flowers) and structures for constituting a space (for example, doors, windows, pillars, stairs, and fireplaces). A set of landmarks may include at least one landmark.

A landmark may be determined corresponding to a location of an object. A landmark corresponding to a specific location means that the landmark is disposed at a specific location or adjacent to the specific location.

According to an embodiment of the present disclosure, a landmark corresponding to a current position of an object may represent a landmark disposed at a place where the object is currently positioned. For example, when a user is sitting on a chair, a landmark corresponding to a current position of the user may be determined as the chair. Further, a landmark corresponding to a current position of an object may represent a landmark disposed adjacent to a place where the object is currently disposed. For example, when a user opens a door of a refrigerator, a landmark corresponding to a current position of the user may be determined as a refrigerator. According to an embodiment of the present disclosure, a landmark corresponding to a current position of an object may include one or more landmarks. For example, when a user stands in front of a picture frame hanging on a wall and there is a flowerpot under the picture frame, a landmark corresponding to a current position of the user may include a wall, a picture frame, and a flowerpot. The robot 100 may track an object based on a landmark corresponding to a current position of the object.

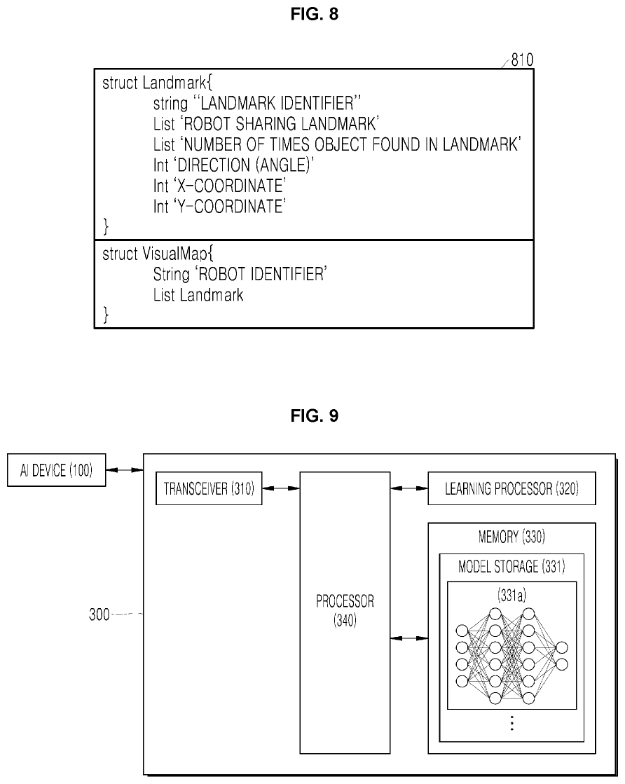

According to an embodiment of the present disclosure, when a landmark corresponding to a current position of an object is a plurality, the processor 170 may select one landmark based on information identifying a number of times the object is found in the landmark with reference to FIG. 8. For example, information on the number of times the object is found in the landmark may be determined as a value obtained by accumulating the number of times the corresponding landmark was determined as an initial position of the object in the past. According to an embodiment of the present disclosure, the processor 170 may determine a landmark, which has the greatest number of times the object is found in the landmark from the plurality of landmarks, as a landmark corresponding to a current position of the object.

In step 520, the processor 170 may determine an initial position of an object based on a potential position of the object. For example, when determining the initial position of the object, the processor 170 is further configured to direct a field of view of the sensor 140 towards a potential position of the object. The potential position of the object refers to a predicted position where the object may potentially appear. The initial position of the object refers to a location where the object is initially found in a space where the robot 100 is disposed.

According to an embodiment of the present disclosure, when the robot 100 moves from a third space, where the other robot 100 is disposed, to the space where the robot 100 is disposed, the potential position of the object may be determined based on a last detected position of the object in the third space. The processor 170 may receive information on the third landmark corresponding to a position where the object was lost in the third space, from the other robot 100 disposed at the third space, through the transceiver 110. In other words, the processor 170 may receive information identifying a third landmark corresponding to a position where the object was last detected in another space, and determine the initial position based on the third landmark. For example, the potential position of the object is the third landmark corresponding to the position where the object was lost in the third space where at least one other robot 100 is disposed, and the processor 180 may be configured to determine an initial position of the object based on the third landmark.

Additionally, in step 520, the processor 170 may determine whether the third landmark corresponds to one of the set of landmarks present in a space where the robot 100 is disposed. In other words, the processor 170 may determine whether the third landmark corresponds to a common landmark for the third space and the space where the robot 100 is disposed. According to an embodiment of the present disclosure, when the object moves from the third space, where the other robot 100 is disposed, to the space where the robot 100 is disposed, the potential position of the object may be determined based on the sound source location by using the estimation of the sound source location of the input sound triggered from the object. For example, the potential position of the object is a sound source location acquired by estimating the sound source location of the input sound triggered by the object, and the processor 170 may be configured to determine an initial position of the object based on the sound source location.

Step 520 may include directing a field of view of a robot towards a potential position of an object. In step 520, the processor 170 may direct a field of view of the robot 100 towards a potential position of an object. Here, the directing a field of view of the robot 100 towards a specific location refers to setting a direction of the camera 121 towards the corresponding specific location by controlling a motor configured to adjust the direction of the camera 121.

In step 520, the processor 170 may track the object by moving the field of view of the robot 100 based on the potential position of the object. For example, the processor 170 may cause a driver to perform rotational movement of the body of the robot 100 and scan a surroundings of the potential position via the camera 121. The processor 170 tracks the object based on an image acquired by scanning the surroundings of the potential position, and upon finding the object, determines a location where the object is found as an initial position of the object.

In step 520, the processor 170 may update the information on the set of landmarks obtained from step 510 based on the landmark corresponding to the initial position of the object. For example, the processor 170 may add the information on the landmark corresponding to the initial position of the object to the information on the set of landmarks stored in the memory 160. For example, the processor 170 may update information identifying the number of times the user is found in the landmark corresponding to the initial position of the object.

In step 530, the processor 170 may determine at least one first landmark corresponding to a current position of the object from the set of landmarks obtained in step 510. In step 530, the processor 170 may track the movement of the object in the space where the robot 100 is disposed, and determine a first landmark corresponding to a current position of the object from the set of landmarks obtained from step 510.

For example, the processor 170 may extract a landmark from an image capturing the moving object through the camera 121, and determine the extracted landmark as a first landmark. For example, the processor 170 may compare the first landmark with each landmark of the set of landmarks obtained from step 510, determine whether the first landmark is included in the set of landmarks according to the compared result, and add the first landmark to the set of landmarks when the first landmark is not included therein. For example, the processor 170 may additionally store information on the first landmark in the memory 160.

Step 530 may include moving the field of view of the robot according to the movement of the object. In step 530, the processor 170 may be configured to move the field of view of the robot 100 according to the movement of the object so as to determine the first landmark. For example, the processor 170 may track the object based on the image of the object photographed by causing the driver to perform rotational movement of the body of the robot 100.

In step 530, the processor 170 may determine a series of first landmarks corresponding to a current position of the object during the movement of the object, so as to determine the first landmark. The current position of the moving object changes continuously to form a trajectory of the object. The series of first landmarks is a list of landmarks corresponding to the trajectory of the object.

In step 550, the processor 170 may transmit to another device, information identifying a second landmark from the set of landmarks corresponding to a second position of the object in the space. For example, the other device may include at least one other robot 100. Step 550 may include determining the first landmark corresponding to the first position of the object right before the object was lost in the space where the robot 100 is disposed, as a second landmark corresponding to a second position of the object. In step 550, the processor 170 may determine the first landmark corresponding to the current position of the object right before the object was lost in the space where the robot 100 is disposed as a second landmark corresponding to a final position. In other words, the processor 170 is configured to determine, as the second landmark, a last detected one of the at least one first position of the object. Specifically, in step 550, the processor 170 may determine the first landmark corresponding to the current position of the robot 100 determined in step 530 right before the object was lost in the space where the robot 100 is disposed, as a second landmark corresponding to a final position of the robot 100.

In step 550, the processor 170 may transmit the second landmark corresponding to the final position of the robot 100 to at least one other robot 100 through the transceiver 110. For example, at least one other robot 100 may be disposed in a third space different from the space where the robot 100 is disposed.

According to an embodiment of the present disclosure, the processor 170 may transmit a message for informing that the user has been lost from the field of view of the robot 100 to at least one other robot 100 through the transceiver 110. At least one other robot 100 that receives this message tracks the object in the third space where the other robot 100 is disposed. For example, at least one other robot 100 may determine an initial position of the object in the third space where the other robot 100 is located, by using the second landmark as the potential position of the object.

According to an embodiment of the present disclosure, in step 510 to step 550, the robot 100 may be a first robot 101. Further, in step 550, at least one other robot 100 may be a second robot 102. The second robot 102 may include at least one of other second robots 102 different from the first robot 101.

In addition, the method for tracking an object according to an embodiment of the present disclosure may further including generating a visual map that indicates a spatial connection between the robot 100 and at least one other robot 100 based on the information on the set of landmarks obtained from step 510 by the processor 170.

When the robot 100 is initially installed in a space, the robot 100 scans surrounding landmark information by using the camera 121 under the control of the processor 170. The processor 170 may extract information on a set of landmarks present in the space where the robot 100 is disposed by using the object recognition model stored in the memory based on the scanned information.

The robot 100 may store the object recognition model based on an artificial neural network in the memory 160. For example, the object recognition model, as a model obtained by implementing an object detecting technique based on deep learning, may use YoLO (You only Look Once), SSD (Single Shot Detector), Tensorflow Object Detection and CNN (Convolutional Neural Network). The robot 100 may generate information on the set of landmarks present in the space where the robot 100 is disposed by using the object recognition model stored in the memory 160.

The robot 100 may transmit the extracted information on the set of landmarks to at least one other robot 100 that can perform a communication (for example, broadcasting) to share the information. At least one other robot 100 may receive the information on the set of landmarks, and compare the received a set of landmarks with the other set of landmarks stored in the memory 160 to determine a common landmark. At least one other robot 100 may transmit information on the common landmark to all robots 100 that can perform communication.

The processor 170 may update the visual map in a period manner or according to change in the location of the robot 100. For this operation, the processor 170 may scan surrounding landmark information by using the camera 121 in a period manner or according to change in the location of the robot 100. The visual map will be described later with reference to FIG. 8.

FIG. 4 is a diagram illustrating the method for tracking an object according to an embodiment of the present disclosure. FIG. 4 illustrates an exemplary house that uses several robots 100. The exemplary house has a bathrooml 51, a library S2, a bedroom1 S3, a living room S4, and a kitchen S5 in the first floor, and a bedroom2 S6, a bathroom2 S7, and a bedroom3 S8 in the second floor. For example, it is assumed that a robot R1 is disposed in the living room S4, a robot R2 in the library S2, a robot R3 in the kitchen S5, a robot R4 in the bedroom2 S6, and a robot R5 in the bedroom 3 (S8).

Each of the robots R1, R2, R3, R4, and R5 has an equivalent configuration to that of the robot 100 and performs an equivalent operation and function to those of the robot 100. The robots R1, R2, R3, R4, and R5 are exemplary, and the method for tracking an object according to an embodiment of the present disclosure may be performed by more robots or less robots.

The living room S4 and the kitchen S5 have a common landmark (for example, a TV), and it is assumed that the library S2 and the living room S4 are located adjacent to each other within hearing range of each other. Additionally, it is assumed that a noise from the first floor is not heard on the second floor.

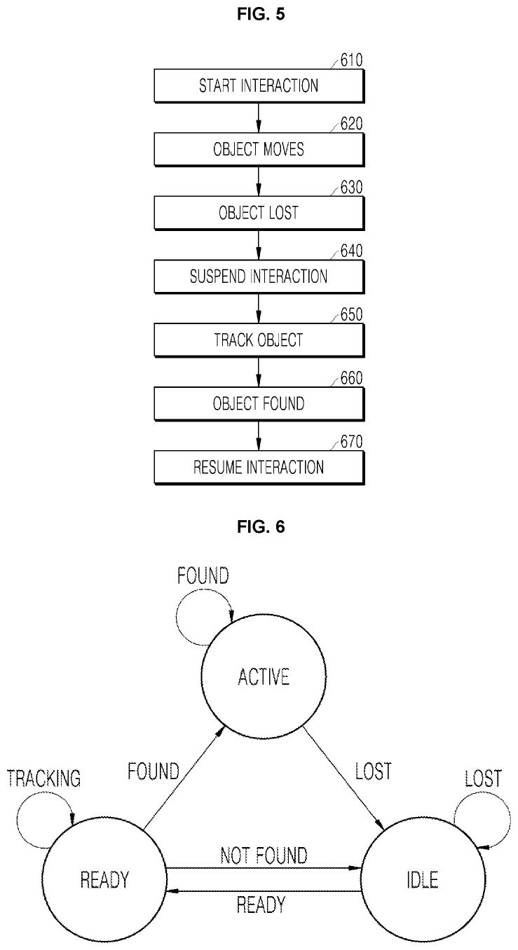

Hereinafter, a process of tracking an object according to an embodiment of the present disclosure is demonstrated as in FIG. 5 with reference to FIG. 4. FIG. 5 is a flow diagram illustrating a process of tracking an object according to an embodiment of the present disclosure.

FIG. 5 shows an example when it is assumed that the object is a user who is interacting with the robot R1 in the living room S4 (for example, a news briefing by the robot R1) in step 610 with reference to FIG. 4. In step 620, the user moves while interacting with the robot R1 in the living room S4. The robot R1 performs an operation according to step 530 with reference to FIG. 3. In other words, the robot R1 may determine a first landmark corresponding to a current position of the user from a set of landmarks present in the living room S4, according to movement of the object in step 530, as mentioned above with reference to FIG. 3. The robot R1 may perform step 620 repeatedly while the user stays in the living room S4. When the user disappears from the living room S4, the robot R1 performs step 630.

In step 630, the user moves out of the living room S4 and is lost from the field of view of the robot R1. The robot R1 performs an operation according to step 550 with reference to FIG. 3. That is, the robot R1 may transmit a second landmark (for example, the TV) corresponding to a final position of the user in the living room S4, to other robots R2, R3, R4, and R5. In step 640, the robot R1 may suspend the interaction with the user. All the robots R1, R2, R3, R4, and R5 start tracking the user in a space where each robot is disposed.

In step 650, all the robots R1, R2, R3, R4, and R5 track a user. For example, all the robots R1, R2, R3, R4 and R5 may track a user for a predetermined tracking time. For example, the predetermined tracking time may have an initial value, a maximum value and a minimum value, and may increase or decrease depending on the time the user is found. All the robots R1, R2, R3, R4, and R5 may perform step 650 until the user is found or before the predetermined tracking time is expired. When the tracking a user succeeds in step 650, the process moves to step 660. Step 650 and step 660 may be included in step 520 with reference to FIG. 3.

For example, in step 650 and step 660, all the robots R1, R2, R3, R4, and R5 may determine an initial position of the user in a space where each robot is disposed based on a potential position of the user according to step 520 with reference to FIG. 3. According to an embodiment of the present disclosure, a portion of the robots R1, R2, R3, R4, and R5 may track the user by using the second landmark corresponding to the final position of the user in the living room S4 and received from the robot R1, as a potential position of the user.

For example, the robot R3 disposed in the kitchen S5 determines whether the second landmark (for example, the TV) received from step 630 corresponds to one of the set of landmarks present in the kitchen S5 where the robot R3 is disposed. As mentioned above, as the TV is the common landmark of the living room S4 and the kitchen S5, the robot R3 regards the TV as a potential position of the user, and tracks the user based on the second landmark so as to determine an initial position of the user in the kitchen S5.

According to another embodiment of the present disclosure, the other portion of the robots R1, R2, R3, R4, and R5 may track the user by using a sound source location acquired via estimation of the sound source location of an input sound triggered by the user, as a potential position of the user.

For example, the robot R2 disposed in the library S2 determines whether the second landmark (for example, the TV) received from step 630 corresponds to one of the set of landmarks present in the library S2. As there is no common landmark between the living room S4 and the library S2 according to the assumption, the TV, which is the second landmark received from step 630, may not be included in the set of landmarks present in the library S2 where the robot R2 is disposed.

In this case, the robot R2 uses an input sound detected through the microphone 122 so as to determine an initial position of the user. According to the assumption, the living room S4 and the library S2 are located within hearing distance of each other. In step 620, while the user moves in the living room S4, the robot R2 detects an input sound such as a voice of the user through the microphone 122 of the robot R2 and acquires a sound source location via estimation of the sound source location of the detected input sound, that is, the location of the user. The robot R2 may track the user based on the sound source location acquired via estimation of the sound source location.

In addition, for example, the robot R5 disposed in the bedroom3 S8 on the second floor determines whether the second landmark (for example, the TV) received from step 630 corresponds to one of the set of landmarks present in the bedroom3 S8. As there is no common landmark between the living room S4 and the bedroom3 S8 according to the assumption, the TV, which is the second landmark received from step 630, may not be included in the set of landmarks present in the bedroom3 S8 where the robot R5 is disposed.

In this case, the robot R5 detects an input sound through the microphone 122 so as to determine an initial position of the user. According to the assumption, the living room S4 and the bedroom3 S5 are not located within hearing distance of each other. The robot R5 may track the user based on the sound source location acquired via estimation of the sound source location of a footstep coming up to the second floor or a voice of the user included in the input sound detected by the microphone 122.

In step 660, the robot (for example, one of R2, R3, R4, and R5) that finds the user may determine an initial position of the user according to the location of where the user is found. In step 670, the robot (for example, one of R2, R3, R4, and R5) that finds the user may resume interaction with the user that was suspended in step 640. As a result, it is possible to provide seamless interaction from the point of view of the user.

FIG. 6 is a diagram illustrating a state transition of the robot according to an embodiment of the present disclosure. The state of the robot 100 includes a ready state, an active state and an idle state.

The ready state refers to a state of tracking an object in a space where the robot 100 is disposed. The robot 100 maintains the ready state while determining an initial position of the object based on a potential position of the object according to step 520 with reference to FIG. 3. When the object is found in the space where the robot 100 is disposed as a result of tracking the object, the robot 100 transitions to the active state. When the object is not found in the space where the robot 100 is disposed as a result of tracking the object, the robot 100 transitions to the idle state.

The active state refers to a state of performing interaction between the robot 100 and the object while the object stays in the space where the robot 100 is disposed. The robot 100 is in the active state while determining the first landmark corresponding to the current position of the object according to the movement of the object in step 530 with reference to FIG. 3. That is, the robot 100 maintains the active state while the object is found in the space where the robot 100 is disposed.

When the object is lost in the space where the robot 100 is disposed, the robot 100 transitions to the idle state. For example, the robot 100 transitions to the idle state after transmitting the second landmark corresponding to the final position of the robot 100 in the space where the robot 100 is disposed, to at least one other robot 100 in step 550 with reference to FIG. 3. According to an embodiment of the present disclosure, when the object is lost in the space where the robot 100 is disposed, the robot 100 transitions to the ready state to track the object.

The idle state refers to the robot 100 remaining idle. The robot 100 enters the idle state and maintains the idle state when the object is lost in the space where the robot 100 is disposed. When the robot 100 receives a ready request from at least one other robot 100, the robot 100 transitions to the ready state. The ready request, which is a message for informing that the object has been lost in the space where the other robot 100, which is currently in the active state, is disposed, may include information on the final position of the object in the space where the other robot 100, which is currently in the active state, is disposed.

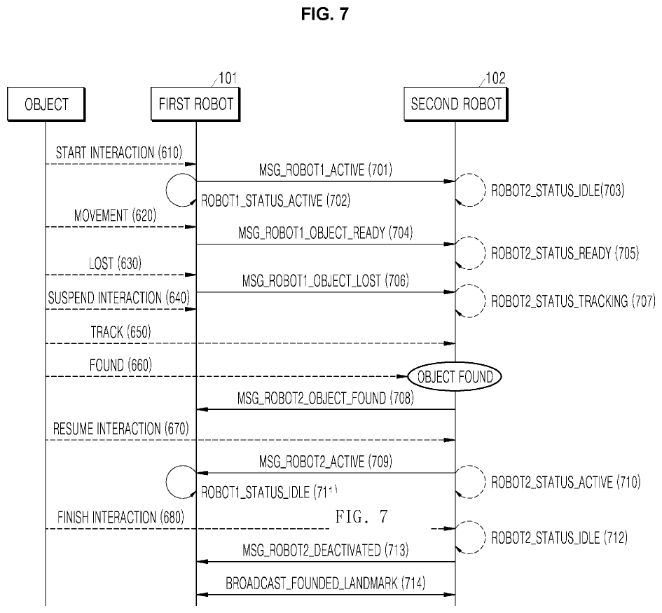

FIG. 7 is a signal flow diagram illustrating the process of tracking an object in a robot system according to an embodiment of the present disclosure. The robot system may include a first robot 101 and a second robot 102. The first robot 101 is disposed in a first space and the second robot 102 is disposed in a second space.

The first robot 101 and the second robot 102 have the equivalent configuration to that of the robot 100 and perform the equivalent operation and function to those of the robot 100. The second robot 102 may include at least one of the second robots 102. That is, the second robot 102 refers to at least one other robot 100 which is separated from the first robot 101. According to an embodiment of the present disclosure, the object moves from the first space to the second space, and the second robot 102 may be configured to determine the initial position of the object in the second space based on the second landmark.

According to an embodiment of the present disclosure, the object moves from the first space to the second space, and the second robot 102 may be configured to track the object while moving a field of view of the second robot 102 to determine the initial position of the object in the second space, maintain the ready state while tracking the object, and move to the active state after the object is found in the second space. According to an embodiment of the present disclosure, as the object moves from the first space to the second space, the first robot 101 is configured to suspend the interaction between the first robot 101 and the object, and the second robot 102 is configured to resume the interaction between the second robot 102 and the object. In other words, the first robot 101 is configured to suspend interaction between the first robot and the object when the object moves from the first space to the second space, and the second robot 102 is configured to interact with the object when the object moves from the first space to the second space.

The signal flow of the robot system from step 610 to step 640 is described. The first robot 101 of the robot system may be configured to determine an initial position of the object based on a potential position of the object in the first space, determine a first landmark corresponding to a current position of the object, from the set of landmarks present in the first space, according to movement of the object in the first space, and transmit a second landmark corresponding to a final position of the object in the first space to the second robot 102.

In step 610, before starting interaction, the first robot 101 determines an initial position of the object based on a potential position of the object in the first space. Subsequently, the first robot 101 starts interaction with the object present in the first space in step 610 with reference to FIG. 5.

In step 701, the first robot 101 transmits a message MSG_ROBOT1_ACTIVE informing that the first robot 101 is in an active state to the second robot 102. For example, the first robot 101 may broadcast the message MSG_ROBOT1_ACTIVE.

In step 702, the first robot 101 sets the first robot 101 to be in the active state. According to an embodiment of the present disclosure, step 702 may be simultaneously performed with step 701 or prior to step 701. In step 703, the second robot 102 receives the message MSG_ROBOT1_ACTIVE from the first robot 101 and sets the second robot 102 to be in an idle state.

In step 620, the object moves in the first space. The first robot 101 tracks the object while the object moves in the first space in step 620. For example, the first robot 101 may determine a first landmark corresponding to a current position of the object, from the set of landmarks present in the first space, according to the movement of the object in the first space.

While performing step 620, the first robot 101 may transmit a message MSG_ROBOT1_OBJECT_READY to the second robot 102, informing that the object is moving from the first space in step 704. The message MSG_ROBOT1_OBJECT_READY corresponds to a message requesting a transition to a ready state, since the object is likely to be found in the space where the second robot 102 is disposed.

In step 705, the second robot 102, which receives the message MSG_ROBOT1_OBJECT_READY, may set the second robot 102 to be in the ready state. For example, the second robot 102 may detect an input sound through the microphone 122 while in the ready state.

In step 630, the object is lost in the first space. For example, it is assumed that the object moves from the first space to the second space in step 630. When the object is lost in the first space in step 630, the first robot 101 transmits a message MSG_ROBOT1_OBJECT_LOST indicating that the object has been lost in the first space to the second robot 102 in step 706.

According to an embodiment of the present disclosure, the first robot 101 may transmit the second landmark corresponding to the final position of the object in the first space to the second robot 102. For example, the message MSG_ROBOT1_OBJECT_LOST may include information on the second landmark.

In step 707, the second robot 102 that receives the message MSG_ROBOT1_OBJECT_LOST tracks the object. According to an embodiment of the present disclosure, the second robot 102 may maintain the ready state while tracking the object. In other words, the second robot 102 may maintain a ready state that includes moving a field of view of the second robot 102 based on the second landmark to search for the object in the second space. According to another embodiment of the present disclosure, the second robot 102 may change the state of the second robot 102 to a tracking state in step 707.

According to an embodiment of the present disclosure, when the object is lost in the first space in step 630, the first robot 101 may track the object in step 707. In this case, the state of the first robot 101 transitions to the ready state or the tracking state.

In step 640, the first robot 101 may suspend the interaction with the object. In step 650, the second robot 102 tracks the object. According to an embodiment of the present disclosure, the second robot 102 may determine the initial position of the object based on the potential position of the object in the second space.

For example, the second robot 102 may determine an initial position of the object based on information on the second landmark included in the message MSG_ROBOT1_OBJECT_LOST received in step 706. For example, the second robot 102 may determine an initial position of the object based on a sound source location determined via estimation of the sound source location of an input sound triggered by the object.

When the object is found by the robot 102 in step 660, the second robot 102 transmits a message MSG_ROBOT2_OBJECT_FOUND informing that the object is found, to the first robot 101 and the other robot 102 in step 708. The second robot 102 may resume the interaction with the object when the object is found in step 670.

In step 709, the second robot 102, which finds the object, transmits a message MSG_ROBOT2_ACTIVE informing that the second robot 102 itself is in an active state, to the first robot 101 and the other second robot 102. For example, the second robot 102 may broadcast the message MSG_ROBOT2_ACTIVE.

In step 710, the second robot 102, which finds the object, sets itself to be in the active state. According to an embodiment of the present disclosure, step 710 may be simultaneously performed with step 709 or prior to step 709.

In step 711, the first robot 101, which receives the message MSG_ROBOT2_ACTIVE, sets the state of the first robot 101 to be in an idle state. According to an embodiment of the present disclosure, the second robot 102 may determine a landmark corresponding to a current position of the object, from the set of landmarks present in the second space, according to the movement of the object in the second space, while performing interaction with the object in the second space.

When the interaction with the object is finished in step 680, the second robot 102 may set the state of the second robot 102 to be in the idle state in step 712 and broadcast a message MSG_ROBOT2_DEACTIVATED informing that the second robot 102 has finished the interaction and is deactivated in step 713.

Additionally, the second robot 102, which finds the object in step 660, may broadcast information on the landmark corresponding to a location where the object is found in step 714. For example, the second robot 102 may broadcast information on the landmark corresponding to the initial position of the object in the second space.

Both the first robot 101 and the second robot 102 may update the visual map stored in the memory 160 based on information on the landmark shared in step 714. For example, the first robot 101 and the second robot 102 may update information on the number of times the user is found in the landmark and information on the robot that shares the landmark among information on landmarks described later with reference to FIG. 8.

According to another embodiment of the present disclosure, the object may move from the second space to the first space or to a third space while performing the interaction with the second robot 102 without having finished the interaction in step 680. In this case, the second robot 102 may transmit a third landmark corresponding to a location where the object is lost in the second space, to the first robot 101 and the other second robot 102 according to step 630. The first robot 102 and the other second robot 102 may track the object in step 650 and continue the interaction with the object according to the subsequent step. As a result, it is possible to provide the robot system capable of performing seamless interaction.

FIG. 8 is a table illustrating a visual map according to an embodiment of the present disclosure. Table 810 shown in FIG. 8 illustrates the structures of data on the landmark and the visual map. The data structure of Table 810 is an example, of which embodiments are not limited thereto, and the landmark and visual map may be implemented with various types of data structures including an additional field.

The illustrated data structure of the landmark stores information on landmarks. For example, the information on landmarks may include, for each of the landmarks, an identifier of a landmark, information on at least one other robot that shares the landmark, information identifying a number of times the object is detected at the landmark, and location information on the landmark for each landmark.

For example, the identifier of the landmark includes a unique number given to the landmark. For example, the information on the robot that shares the landmark includes a list of the robot 100 for storing the landmark as a common landmark. Here, the list of the robot 100 may be a list of an identifier of the robot 100. For example, information identifying the number of times the object is found in the landmark may be the number of times the landmark is determined as an initial position of the object in a specific space. For example, the location information on the landmark may include a direction and a coordinate of the landmark. Here, the direction may be represented by an angle to the landmark based on a current position or a reference position of the robot 100. Here, the coordinate may be represented by plane coordinates (ex. x-coordinate and y-coordinate) or special coordinates (ex. x-coordinate, y-coordinate and z-coordinate) based on the origin as the current position or the reference position.

The illustrated data structure of the visual map may include an identifier of the robot 100 and a list of landmarks. The identifier of the robot 100 may include a unique number given to at least one of the robots 100 for constituting the robot system. The list of landmarks stores information on a set of landmarks present in a space where the robot 100 is disposed, the robot 100 being mapped by the identifier of the robot 100. For example, the list of landmarks may be implemented as a list of the aforementioned data structure of the landmark.

According to an embodiment of the present disclosure, each of the robots 100 for constituting the robot system may generate a visual map and store the visual map in the memory 160, and each robot 100 may manage and update its own visual map. For example, the visual map generated in each robot 100 may be stored in the memory 160 of the robot 100 corresponding to the identifier of the robot 100.

According to an embodiment of the present disclosure, the server 300 may generate a visual map for each robot 100 that constitutes the robot system and also store the visual map in a memory 330 of the server 300 as a list of the visual maps with reference to FIG. 9.

FIG. 9 is a block diagram illustrating a server according to an embodiment of the present disclosure. The server 300 may refer to a control server for controlling the robot 100. The server 300 may be a central control server for monitoring a plurality of robots 100. The server 300 may store and manage state information of the robot 100. For example, the state information may include location information on the robot 100, interaction information in progress, and battery information on the residual capacity.

The server 300 may store and manage the landmark information. The server 300 may update the landmark information and transmit the updated landmark information to the robot 100. For example, the server 300 may transmit information on a common landmark to the robot 100.

Meanwhile, the server 300 may receive a result of tracking the object from the robot 100. For example, the server 300 may receive messages of informing events generated and warnings from the robot 100. The server 300 may transmit the received information on the events and warning messages to the terminal 200.

The server 300 may refer to a device for training an artificial neural network using a machine learning algorithm or using a trained artificial neural network. Here, the server 300 may include a plurality of servers to perform distributed processing, or may be defined as a 5G network. The server 300 may also be included as a configuration of a portion of an AI device, such as the robot 100, to thereby perform at least some of the AI processing together with the AI device.

The server 300 may include a transceiver 310, a memory 330, a learning processor 320, and a processor 340. The transceiver 310 may transmit and receive data to and from an external device, such as the robot 100.

The memory 330 may include a model storage 331. The model storage 331 may store a model (or an artificial neural network 331a) that is being trained or has been trained via the learning processor 320. For example, the memory 330 may store the object recognition model based on the artificial neural network.

The learning processor 320 may train the artificial neural network 331a by using learning data. The learning model may be used while mounted in the server 300 of the artificial neural network, or may be used while mounted in an external device such as the robot 100, or the like. For example, the learning model may be equipped in the server 300 or in the robot 100 and used to recognize a landmark.

The learning model may be implemented as hardware, software, or a combination of hardware and software. When a portion or the entirety of the learning model is implemented as software, one or more instructions, which constitute the learning model, may be stored in the memory 330. The processor 340 may infer a result value with respect to new input data using the learning model, and generate a response or control command based on the inferred result value.

The example embodiments described above may be implemented through computer programs executable through various components on a computer, and such computer programs may be recorded on computer-readable media. In this case, examples of the computer-readable media may include, but are not limited to: magnetic media such as hard disks, floppy disks, and magnetic tape; optical media such as CD-ROM disks and DVD-ROM disks; magneto-optical media such as floptical disks; and hardware devices that are specially configured to store and execute program instructions, such as ROM, RAM, and flash memory devices.

The computer programs may be those specially designed and constructed for the purposes of the present disclosure or they may be of the kind well known and available to those skilled in the computer software arts. Examples of program code included both machine codes, such as produced by a complier, and higher-level code that may be executed by the computer using an interpreter.

As used in the present disclosure (especially in the appended claims), the singular forms “a,” “an,” and “the” include both singular and plural references, unless the context clearly states otherwise. Also, it should be understood that any numerical range recited herein is intended to include all sub-ranges subsumed therein (unless expressly indicated otherwise) and accordingly, the disclosed numerical ranges include every individual value between the minimum and maximum values of the numerical ranges.

The order of individual steps in process claims according to the present disclosure does not imply that the steps must be performed in this order; rather, the steps may be performed in any suitable order, unless expressly indicated otherwise. In other words, the present disclosure is not necessarily limited to the order in which the individual steps are recited. All examples described herein or the terms indicative thereof (“for example,” etc.) used herein are merely to describe the present disclosure in greater detail. Therefore, it should be understood that the scope of the present disclosure is not limited to the exemplary embodiments described above or by the use of such terms unless limited by the appended claims. Also, it should be apparent to those skilled in the art that various modifications, combinations, and alternations can be made depending on design conditions and factors within the scope of the appended claims or equivalents thereof.

It should be apparent to those skilled in the art that various substitutions, changes and modifications which are not exemplified herein but are still within the spirit and scope of the present disclosure may be made. While the specific exemplary embodiments of the present disclosure have been described above and illustrated, it will be understood by those skilled in the art that the present disclosure is not limited to the described exemplary embodiments, and various modifications and alterations may be made without departing from the spirit and the scope of the present disclosure. Therefore, the scope of the present disclosure is not limited to the above-described exemplary embodiments, but shall be defined by the technical thought as recited in the following claims.

An aspect of the present disclosure is to provide a robot that provides interaction for a moving object. Another aspect of the present disclosure is to provide a robot system that tracks an object by working in collaboration with a plurality of robots. Still another aspect of the present disclosure is to provide a method for tracking an object without using lidar and a depth camera.

The present disclosure is not limited to what has been described above, and other aspects not mentioned herein will be apparent from the following description to one of ordinary skill in the art to which the present disclosure pertains. Provided is a robot, according to an embodiment of the present disclosure, that generates a visual map based on a set of landmarks disposed in a space and finds a position of a user who moves based on the visual map.

The robot may include a memory configured to store information on a set of landmarks present in a space where the robot is disposed, and a processor coupled to the memory. The processor included in the robot may determine an initial position of an object based on a potential position of the object, determine a first landmark corresponding to a current position of the object from the set of landmarks according to movement of the object, and transmit a second landmark corresponding to a final position of the object to at least one other robot.

A robot system is provided, according to an embodiment of the present disclosure, which shares landmark information corresponding to a position of a user where multiple robots move. The robot system may include a first robot and a second robot. The first robot is disposed in a first space and the second robot is disposed in a second space. The first robot is configured to determine an initial position of an object based on a potential position of the object, determine a first landmark corresponding to at least one first position of the object from a set of landmarks present in the first space, according to movement of the object in the first space, and transmit a second landmark corresponding to a second position of the object to the second robot in the first space.

Provided is a method, according to an embodiment of the present disclosure, for storing an object and a place where there is a possibility of finding an object or where the object is found as a landmark and tracking the object based on the landmark.

The method for tracking an object may include obtaining a set of landmarks present in a space where a robot is disposed, determining an initial position of an object based on a potential position of the object, determining a first landmark corresponding to a current position of the object from the set of landmarks, according to movement of the object, and transmitting a second landmark corresponding to a final position of the object to at least one other robot.

Aspects which can be achieved by the present disclosure are not limited to what has been disclosed herein above and other aspects can be clearly understood from the following description by those skilled in the art to which the present disclosure pertains.

According to embodiments of the present disclosure, it is possible that an object which interacts with a robot may seamlessly use multiple robots as if using a single robot, regardless of location of the object. According to embodiments of the present disclosure, a moving object is tracked and a robot adjacent to the object is automatically activated, thereby enhancing user convenience. According to embodiments of the present disclosure, it is possible to effectively track a location of an object without using other equipment such as lidar and a depth camera.

It should be noted that effects of the present disclosure are not limited to the effects of the present disclosure as mentioned above, and other unmentioned effects of the present disclosure will be clearly understood by those skilled in the art from an embodiment described below.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to cross-section illustrations that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A robot comprising:
a memory configured to store information on a set of landmarks present in a space associated with the robot;
a transceiver;
a sensor; and
a processor coupled to the memory, wherein the processor is configured to:
determine an initial position of an object;
determine at least one first landmark, from the set of landmarks, corresponding to at least one first position of the object detected by the sensor during a movement of the object in the space; and
control the transceiver to transmit, to another device, information identifying a second landmark, from the set of landmarks, corresponding to a second position of the object in the space.

2. The robot of claim 1, wherein the processor, when determining the initial position of the object, is further configured to direct a field of view of the sensor towards a potential position of the object.

3. The robot of claim 1, wherein the processor is further configured to:
receive information identifying a third landmark corresponding to a position where the object was last detected in another space, and
determine the initial position based on the third landmark.

4. The robot of claim 3, wherein the processor is further configured to determine whether the third landmark corresponds to one of the set of landmarks.

5. The robot of claim 1, wherein the processor is further configured to:
determine a sound source location of an sound associated with the object, and determine the initial position based on the sound source location.

6. The robot of claim 1, wherein the processor is further configured to update the information on the set of landmarks based on a landmark corresponding to the initial position.

7. The robot of claim 1, wherein the processor is further configured to move a field of view of the sensor according to the movement of the object to determine the at least one first landmark.

8. The robot of claim 1, wherein the processor is further configured to determine a series of the first landmarks corresponding to first positions of the object during the movement of the object.

9. The robot of claim 1, wherein the processor is further configured to determine, as the second landmark, a last detected one of the at least one first position of the object.

10. The robot of claim 1, wherein the processor is further configured to generate a visual map of the space based on the information on the set of landmarks.

11. The robot of claim 10, wherein the processor is further configured to update the visual map at least one of periodically or according to a change in a location of the robot.

12. The robot of claim 1, wherein the information on the set of landmarks includes, for each of the landmarks:
an identifier of the landmark,
information on at least one other robot that shares the landmark,
information identifying a number of times the object is detected at the landmark, and
information on a position of the landmark.

13. A method for tracking an object by a robot, the method comprising:
determining a set of landmarks present in a space;
determining an initial position of the object;
determining a first landmark, of the set of landmarks, corresponding to a detected position of the object during a movement of the object; and
transmitting, to another device, information identifying a second landmark, of the set of landmarks, corresponding to a second position of the object.

14. The method of claim 13, wherein determining the initial position of the object includes directing a field of view of the robot towards a potential position of the object.

15. The method of claim 14, wherein determining the first landmark includes moving the field of view of the robot according to the movement of the object.

16. The method of claim 13, wherein the second landmark corresponds to a last detected location of the object in the space.

17. A robot system comprising:
a first robot; and
a second robot,
wherein the first robot is associated with a first space, and the second robot is associated with a second space that differs from the first space, and
wherein the first robot is configured to:
determine at least one landmark, from a set of landmarks in the first space, associated with at least one position of the object in the first space; and
transmit, to the second robot, information identifying a second landmark, of the set of landmarks, corresponding to a last detected position of the object in the first space.

18. The robot system of claim 17,
wherein the object moves from the first space to the second space, and
wherein the second robot is configured to determine an initial position of the object in the second space based on the second landmark.

19. The robot system of claim 17,
wherein the object moves from the first space to the second space, and
wherein the second robot is configured to:
maintain a ready state that includes moving a field of view of the second robot based on the second landmark to search for the object in the second space; and
switch to an active state after finding the object in the second space.

20. The robot system of claim 17, wherein as the object moves from the first space to the second space,
the first robot is further configured to suspend interaction between the first robot and the object when the object moves from the first space to the second space, and
the second robot is configured to interact with the object when the object moves from the first space to the second space.
